(19) United States
(12) Patent Application Publication
(10) Pub. No.: US 2005/0254796 A1
(43) Pub. Date: Nov. 17, 2005

(54) AV information processing system supporting trans-rate recording and time-slip playback

(75) Inventor: Gou Tomita, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/127,303

(22) Filed: May 12, 2005

(30) Foreign Application Priority Data
May 13, 2004 (JP) 2004-143647

(51) Int. Cl. H04N 5/781

(52) U.S. Cl. 386/125; 386/126

(57) ABSTRACT

This system includes a first video decoder which decodes source video data, an encoder which re-encodes a signal decoded by this decoder to rate-converted video data at a rate different from that of the source video data, and a digital AV recorder which records and plays back source audio data corresponding to the source video data, and the re-encoded rate-converted video data. This system also includes a second video decoder which decodes the rate-converted video data played back during recording of the source audio data and rate-converted video data, and an audio decoder which decodes the source audio data played back during recording of the source audio data and rate-converted video data.

### CROSS-REFERENCE TO RELATED APPLICATIONS

This application is based upon and claims the benefit of priority from prior Japanese Patent Application No. 2004-143647, filed May 13, 2004, the entire contents of which are incorporated herein by reference.

### BACKGROUND OF THE INVENTION

1. Field of the Invention

The present invention relates to a system which performs time-slip/follow-up playback of recorded AV information while performing recording (video-recording) by changing the rate of source AV (audio/video) information to be recorded and, more particularly, to a digital recorder and digital TV using such system.

2. Description of the Related Art

In recent years, DVD-VR (DVD-video recording) and HDD (hard disk) digital recorders and the like that exploit MPEG to encode/decode (compress/decompress) digital AV information have been developed and have prevailed for consumer use. Some products of these recorders allow time-slip playback (a playback method that makes follow-up playback of the contents during video recording in parallel with a video recording process) using high-speed access to a recording medium (disc) (see Jpn. Pat. Appln. KOKAI Publication No. 2002-298551 or 2001-216730).

In contrast, in view of the capacity of a medium used in video recording, and a video recording time, trans-rate recording (rate conversion recording) that performs video recording by setting a lower recording rate than that required for high-quality recording which does not impair the quality of source AV information is often used. For example, by performing video recording with standard SD image quality at a recording rate ½ to ⅓ that required to record a Hi-Vision HD broadcast with high image quality, the video recording time on the medium can be prolonged to 2 to 3 times.

When the trans-rate recording is made using a DVD-VR (or HDD) recorder with the time-slip playback function, two sets of MPEG video/audio decoders are normally required. In this case, for example, the first set of decoders decode source information (HD), and the decoded source information is re-encoded to be converted into information (SD) of another rate, thus recording the information. In order to perform time-slip/follow-up playback of the program (an HD program with SD image quality) recorded in this way, the second set of decoders is used. However, the MPEG video/audio decoders are parts with relatively high cost, and use of two sets of such decoders is undesirable in terms of product cost. As one of practical measures against such problem, a multi-decode compatible MPEG decoder may be adopted.

Normally, a multi-decode compatible MPEG decoder is designed to simultaneously display multi-video images, and includes a plurality of (two) video decoders but only one audio decoder. When trans-rate video recording/time-slip playback are implemented by such a multi-decode compatible MPEG decoder, how to cope with only one audio decoder poses a problem.

### BRIEF SUMMARY OF THE INVENTION

An AV information processing system according to an embodiment of the present invention implements trans-rate video recording/time-slip playback of digital AV information using only one audio decoder (or using one of a plurality of audio decoders if they are available).

The system may comprise: a first video decoder which provides a first video signal (analog) by decoding source video data (e.g., HD digital with high-definition image quality); an encoder which re-encodes the first video signal decoded by the first video decoder to rate-converted video data (e.g., SD digital with standard image quality) at a rate different from the source video data; and a digital recorder/player (DVD-VR/HDD recorder) which records and plays back source audio data (not rate-converted normally) corresponding to the source video data and the re-encoded rate-converted video data.

This system may further comprise: a second video decoder which provides a second video signal (analog) by decoding the rate-converted video data played back from the digital recorder/player while the digital recorder/player records the source audio data and the rate-converted video data; and an audio decoder which provides an audio signal (analog, linear PCM digital, or the like) by decoding the source audio data played back from the digital recorder/player while the digital recorder/player records the source audio data and the rate-converted video data.

The aforementioned system can further comprise a buffer which temporarily stores the source audio data, and outputs the stored source audio data at a timing synchronous with the re-encoded rate-converted video data.

With the above arrangement, upon implementing both the rate conversion recording (trans-rate recording) and follow-up playback (time-slip playback), two video-system decoders are used, but only one audio-system decoder may be required to perform time-slip/follow-up playback.

When synchronization (e.g., lip sync) between audio-system data with video-system data which includes a time delay due to the rate conversion process is to be accurately attained, an audio delay process is executed by temporarily storing the audio-system data in the buffer. In this way, the video and audio data timings are synchronized, and video data (rate-converted) and audio data whose timings have been synchronized are recorded as AV data for follow-up playback (the process in time-slip processor 34 in one embodiment). Hence, video/audio synchronization of that playback AV data (AV data of trans-rate recording and time-slip/follow-up playback) can be assured.

### BRIEF DESCRIPTION OF THE SEVERAL VIEWS OF THE DRAWING

FIG. 1 is a block diagram for explaining an AV information processing system (e.g., a digital TV with a digital AV recorder) which supports trans-rate recording (rate conversion recording) and follow-up playback (time-slip playback) according to an embodiment of the present invention;

FIG. 2 is a flowchart for explaining an example of the system operation shown in FIG. 1 upon execution of trans-rate recording and time-slip/follow-up playback;

FIG. 3 is a view for explaining a display example of a dialog which prompts the user to set whether or not follow-up playback (time-slip playback) is to be made;

FIG. 4 is a view for explaining a display example of a dialog which prompts the user to set whether or not rate conversion recording is to be performed, and a time period (minutes) to be recorded by rate conversion; and

FIG. 5 shows a P-in-P display example during time-slip/follow-up playback and an on-screen display example of video recording information.

### DETAILED DESCRIPTION OF THE INVENTION

(Overview)

In a digital TV or the like, in order to observe MPEG-encoded video and audio data, at least one MPEG decoder device is required. When the MPEG video and audio data during observation are to be recorded as MPEG-encoded data, digital data during observation can be directly recorded. In contrast, a method of recording digital data by lowering the rate of a Hi-vision program in place of the digital data itself (trans-rate recording) is available. As a method of performing trans-rate recording, an analog output of the MPEG decoder used in observation is input to an MPEG encoder, which re-encodes that analog output to MPEG digital data with a lower rate, and the re-encoded data is recorded.

When video and audio data during recording are to be played back going back in time without interrupting the recording process, the system requires another decoder. As a practical device that can meet such request, a multi-decode compatible decoder is available. However, since the multi-decode compatible decoder is designed to simultaneously display multi-video images, it can decode a plurality of video images, but it often has only one audio decoder. In one embodiment of the present invention to be described hereinafter, a system is realized, which performs a trans-rate encode process using an encoder during a signal process, uses two video decoders and one audio decoder, and implements follow-up (time-slip) playback of MPEG audio data, which is being recorded, by this one audio decoder.

(Practical Example of System Arrangement)

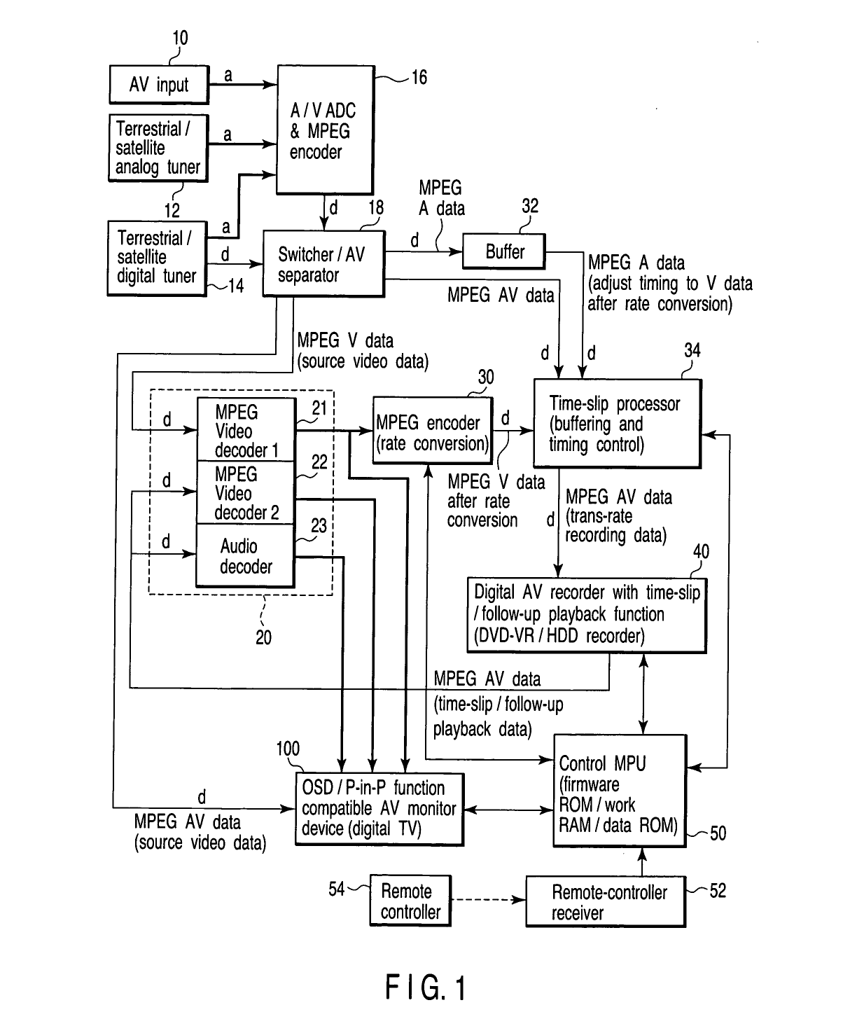

One embodiment of the present invention will be described hereinafter with reference to the accompanying drawings. FIG. 1 is a block diagram for explaining an AV information processing system (a digital TV with a digital AV recorder or the like) which supports trans-rate recording (rate conversion recording) and follow-up playback (time-slip playback) according to an embodiment of the present invention.

The system shown in FIG. 1 is configured on the assumption of a digital TV or AV monitor, which includes an AV recorder (DVD-VR recorder/HDD recorder or the like) that digitally records/plays back an analog AV input. In this system arrangement, analog AV signal a from analog AV input unit (line input) 10, analog AV signal a from terrestrial satellite analog tuner 12, and analog AV signal a from terrestrial/satellite digital tuner 14 are input to MPEG encoder 16 which incorporates a signal selector function and A/D (analog-to-digital) conversion function. In encoder 16, one of analog AV signals a from the line input, analog tuner, and digital tuner is selected, and audio and video components of selected analog AV signal a are converted into digital data, thus generating MPEG-encoded digital AV data d. This MPEG-encoded digital AV data d and digital AV data d from terrestrial/satellite digital tuner 14 are input to AV separator 18 that incorporates a switcher function.

In switcher/AV separator 18, digital AV data d from encoder 16 or tuner 14 is selected, and selected digital AV data d (MPEG AV data) is output to AV monitor device 100 such as a digital TV or the like (if AV monitor device 100 has a digital input). In switcher/AV separator 18, video components (MPEG V data) d and audio components (MPEG A data) d corresponding to the video components are separated from selected digital AV data d. Separated audio components (MPEG A data) d are temporarily stored in buffer 32 to be delayed a predetermined period of time, and are then sent to time-slip processor 34. When audio components are not delayed a predetermined period time, MPEG AV data (audio+video data) d is directly sent to time-slip processor 34.

Video components (MPEG V data) d separated by switcher/AV separator 18 are input to first MPEG video decoder 21. This decoder forms single-chip IC 20 together with second MPEG video decoder 22 and audio decoder 23, or is integrated on circuit board 20 that incorporates these decoders (21 to 23). Decoders 22 and 23 will be described later. MPEG V data input to first MPEG video decoder 21 is decoded into an analog video signal, which is input to MPEG encoder 30 for rate conversion. The decoded analog video signal is sent to an analog video input of AV monitor device 100.

A video encode (re-encode) rate in MPEG encoder 30 can be selected automatically in accordance with the resolution of an input signal or in accordance with a command from control MPU 50 based on a user operation. For example, assume that a terrestrial digital HD broadcasting program is selected by switcher/AV separator 18, MPEG video data (source video data) of the selected digital HD broadcast is decoded into an analog HD signal by MPEG video decoder 21, and this analog HD signal is sent to AV monitor device 100 and MPEG encoder 30. If digital AV recorder 40 (to be described later) supports high-definition HD recording (HD recording corresponding to D3 or D4, or the like, MPEG encoder 30 can perform an MPEG video encode process without changing the HD resolution. If digital AV recorder 40 (to be described later) does not support HD recording but can perform only SD recording (SD recording corresponding to D2, D1, or half D1), MPEG encoder 30 can automatically perform an MPEG video encode process while rate-converting the analog HD signal to a supported resolution (e.g., D1).

On the other hand, for example, even when digital AV recorder 40 supports HD recording, the recordable capacity of a disc to be used may fall short for the HD video recording time. In such case, if the user wants to increase the video recording time by SD recording, MPEG encoder 30 executes rate conversion that lowers the recording rate to a level at which a required video recording time can be assured (e.g., ⅔·D1 level) in accordance with a command from MPU 50 based on the user instruction. Rate-converted MPEG V data d is supplied to time-slip processor 34.

Since it takes a certain period of time to execute the signal processes from MPEG decoder 21 to MPEG encoder 30, video/audio synchronization (lip sync or the like) of MPEG A data d immediately after it is output from switcher/AV separator 18, and MPEG V data d from encoder 30 cannot often be achieved. This video/audio synchronization can be achieved by generating MPEG AV data d for recording by combining MPEG A data d delayed by the buffer 32 with MPEG V data d from encoder 30 in time-slip processor 34 (an actual delay time of buffer 32 is adjusted for each actual apparatus).

MPEG AV data d obtained in this way (trans-rate recording data) is supplied to and recorded by digital AV recorder with the time-slip/follow-up playback function. This digital AV recorder 40 can have the same arrangement as that of a currently commercially available DVD-VR recorder and/or HDD (hard disk) recorder (it may have the same arrangement as that of a recorder using a large-capacity flash memory in future).

A command by a user operation is input from, e.g., remote controller 54. This user operation command is sent to control MPU 50 via remote-controller receiver 52. When the user instructs to perform follow-up playback (time-slip playback) of a program during video recording from remote controller 54, time-slip processor 34 and digital AV recorder 40 enter a time-slip/follow-up playback process. That is, while MPEG AV data during video recording is buffered by a buffer memory (not shown) in time-slip processor 34, recorder 40 plays back already recorded MPEG AV data and buffers playback data by utilizing its high-speed access. While the buffered playback data is supplied to MPEG video decoder 22 and audio decoder 23, MPEG AV data for video recording, which is buffered in time-slip processor 34, is recorded on a recording medium (DVD-RAM disc, HDD, or the like; not shown). In this way, time-slip/follow-up playback of the already recorded contents can be made without interrupting the video recording process.

MPEG video decoder 22 decodes MPEG V data which is played back in the time-slip/follow-up playback mode, and outputs a decoded analog video signal (SD signal in this example) to AV monitor device 100. Also, audio decoder 23 decodes MPEG A data which is played back in the time-slip/follow-up playback mode, and outputs a decoded analog audio signal to AV monitor device 100 (which also has an audio playback function).

Note that various encoding formats such as MP2, MP3, MPEG ACC (5.1 ch), AC-3(R), linear PCM, and the like are available as the encode format of audio data to be decoded by decoder 23. Decoder 23 can be configured to output decoded digital audio data and/or to output an analog audio signal obtained by D/A (digital-to-analog) converting the decoded digital audio data.

AV monitor device 100 can display one or two or more arbitrary ones of a recorded video image before rate conversion from MPEG video decoder 21, a time-slip/follow-up playback video image after rate conversion from MPEG video decoder 22, and source video data from switcher/AV separator 18 (although it depends on its product specifications). This AV monitor device 100 can comprise a digital TV having a multi-video image simultaneous display function (picture-in-picture=P-in-P or double-window display function) in addition to an on-screen display (OSD) function, or a monitor of a personal computer.

With the above arrangement, upon executing both rate conversion recording (trans-rate recording) and follow-up playback (time-slip playback), two video-system decoders (21, 22) are used, but only one audio-system decoder (23) is required to perform time-slip/follow-up playback.

When synchronization (e.g., lip sync) between audio-system data with video-system data which includes a time delay due to the rate conversion process is to be accurately attained, an audio delay process is executed by temporarily storing the audio-system data in the buffer (32). In this way, the video and audio data timings are synchronized, and video data (rate-converted) and audio data whose timings have been synchronized are recorded as AV data for time-slip/follow-up playback. In this way, video/audio synchronization of that playback AV data (AV data of trans-rate recording and time-slip/follow-up playback) can be assured. If rate conversion recording is skipped, MPEG AV data d is directly transferred from switcher/AV separator 18 to time-slip processor 34 and is recorded directly, thus preventing video and audio timing errors.

(Practical Example of System Operation)

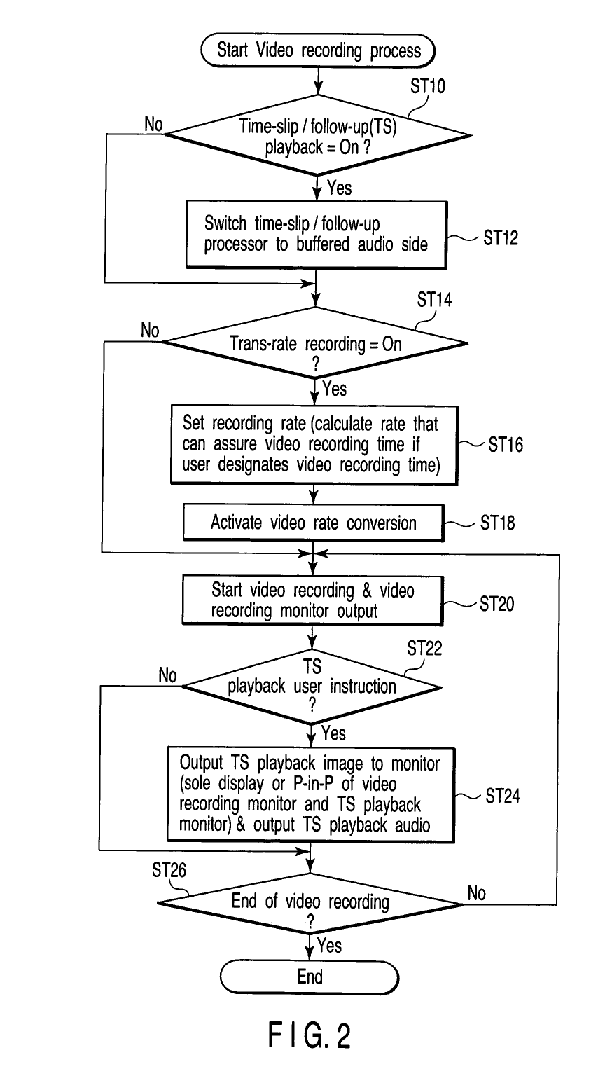

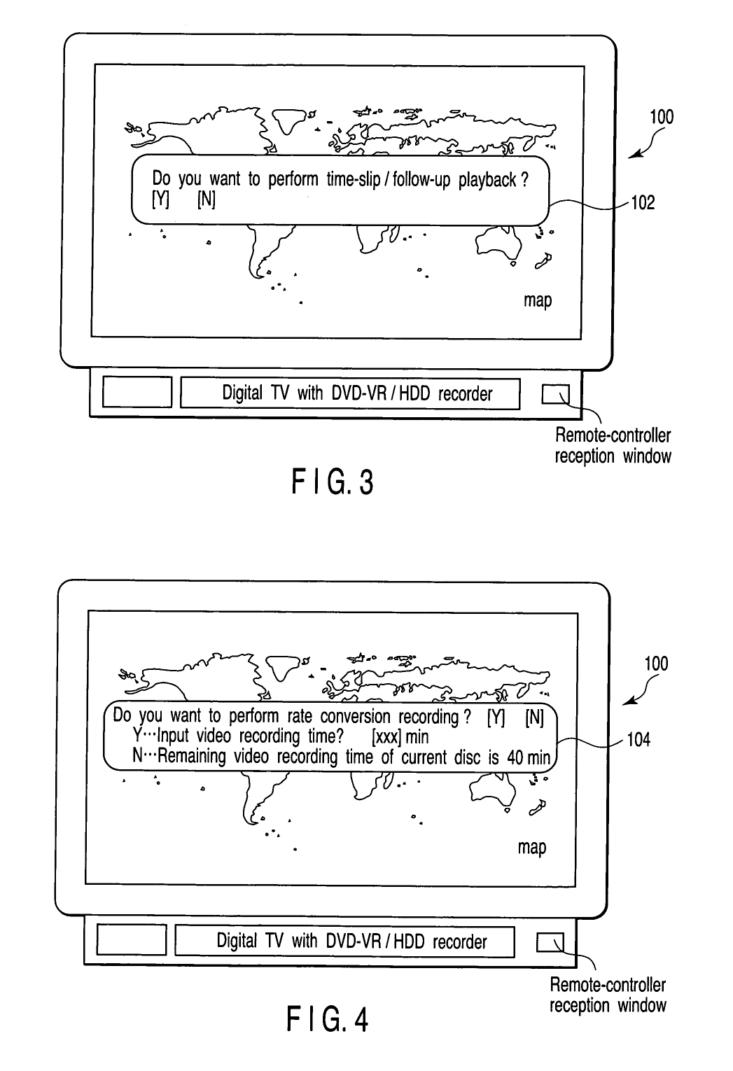

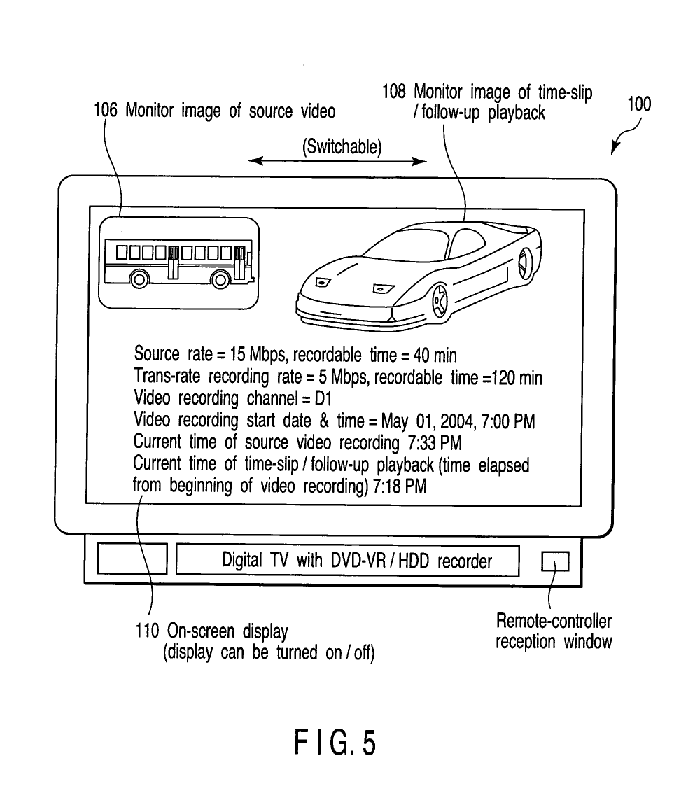

FIG. 2 is a flowchart for explaining an example of the system operation shown in FIG. 1 upon execution of trans-rate recording and time-slip/follow-up playback. FIG. 3 is a view for explaining a display example of a dialog which prompts the user to set whether or not follow-up playback (time-slip playback) is to be made. FIG. 4 is a view for explaining a display example of a dialog which prompts the user to set whether or not rate conversion recording is to be performed, and a time period (minutes) to be recorded by rate conversion. FIG. 5 shows a P-in-P display example during time-slip/follow-up playback and an on-screen display example of video recording information.

In the process shown in FIG. 2, the control inquires the user if time-slip playback (TS playback) is to be made during video recording (step ST10). This inquiry can be issued by displaying dialog 102 shown in, e.g., FIG. 3 on AV monitor device 100 as an OSD image. If the user determines by selecting “time-slip/follow-up playback=Y” by operating the cursor keys and enter key (not shown) of remote controller 54 (Yes in step ST10), time-slip processor 34 is switched to select audio data buffered (delayed) by buffer 32 and video data from MPEG encoder 30 (step ST12). In this case, time-slip processor 34 generates recording AV data using MPEG video data from encoder 30 and MPEG audio data from buffer 32.

Before the beginning of actual video recording, the control inquires the user if rate conversion recording (trans-rate recording) is to be made (step ST14). This inquiry can be issued by displaying dialog 102 shown in, e.g., FIG. 4 on AV monitor device 100 as an OSD image. If the user determines by selecting “rate conversion recording=Y” by operating the cursor keys and enter key (not shown) of remote controller 54 (Yes in step ST14), the recording rate corresponding to this determination is set in MPEG encoder 30 (step ST16).

Some rate determination methods are available. In the first example, the user directly inputs the recording rate (e.g., “5” for 5 Mbps) from the remote controller. In the second example, recording rate candidates which can be set are prepared for user selection (e.g., eight candidates: 2 Mbps, 4 Mbps, 6 Mbps, 8 Mbps, 10 Mbps, 12 Mbps, 16 Mbps, and 20 Mbps), and the user selects one of these candidates using the remote controller while observing the OSD display. In the third example, the control prompts the user to input a time period to be recorded using a recording medium (a DVD-RAM disc or the like; not shown) currently loaded into recorder 40, as shown in FIG. 4. In this case, for example, when the broadcasting rate of a 120-min program is 15 Mbps, and only 40 min can be recorded if the recording rate is 15 Mbps, the user inputs a recording time of 120 min using a numeric keypad (ten-key) input of the remote controller. Then, MPU 50 calculates the average recording rate of 5 Mbps, which is set in MPEG encoder 30 as a rate after rate conversion (step ST16). With this setup, the video rate conversion operation (re-encoding) in MPEG encoder 30 is activated (step ST18).

If “rate conversion recording=N” is selected (No in step ST14), steps ST16 to ST18 are skipped (in this case, in the arrangement shown in FIG. 1, MPEG AV data d from switcher/AV separator 18 is recorded without being re-encoded).

If the rate is set in MPEG encoder 30 and the recorder starts video recording at that rate, a monitor video image during video recording is sent from decoder 21 to AV monitor device 100. In this state, if the user turns on a time-slip key (not shown) on remote controller 54 (Yes in step ST22), the time-slip/follow-up playback process starts (step ST24). That is, of MPEG A data which is played back in the time-slip/follow-up playback mode, video components are input to MPEG video decoder 22, and audio components are input to audio decoder 23. In this manner, a time-slip playback video signal is sent from decoder 22 to the internal video system in monitor device 100, and a time-slip playback audio signal is sent to the internal audio system of monitor device 100. This process (step ST24) continues as long as the user instruction of time-slip playback is active (Yes in step ST22) during video recording (No in step ST26).

A monitor image during time-slip playback may be solely displayed on the monitor. However, for example, that monitor image may be displayed in a picture-in-picture (P-in-P) mode, as shown in FIG. 5. In the example of FIG. 5, monitor image 106 from MPEG video decoder 21 is fitted in and displayed as a small window in a portion (upper left corner in this case) of monitor image 108 during time-slip/follow-up playback. In this display, when monitor device 100 makes 480i display, even if an image from decoder 21 requires 1080i or 720p display, monitor image 106 on the small window is converted into the same number of scan lines as that of monitor image 108 on the main window upon display. In the display example of FIG. 5, related information (the source rate of a program to be recorded, a recordable time at the source rate, the rate of trans-rate recording, a recordable time of the trans-rate recording, time information, program information, and the like) is displayed as OSD image 110 on the lower left side of the main window. This OSD image 110 can be turned on/off by a user's remote-controller instruction or the like. In the P-in-P display in FIG. 5, small monitor image 106 of source video and large monitor image 108 of time-slip/follow-up playback can be arbitrarily replaced from each other by a user's remote-controller instruction or the like.

(Summary of Operation in Embodiment)

<1> Video and audio data of MPEG data input to decoder 20 are normally decoded, and an analog output is input to encoder 30. However, in the operation of this system, video data is decoded, but audio data is not decoded, and only video data is input to encoder 30. At this time, audio decoder 23 is not used.

<2> Audio MPEG digital data is temporarily buffered on recording medium 32 (semiconductor memory such as an SDRAM or the like).

<3> Encoder 30 encodes video data and outputs it as MPEG digital data. Time-slip processor 34 sends this MPEG digital data to digital recorder 40 to record it. In this case, audio MPEG digital data buffered in <2> is output to time-slip processor 34 to be combined with the output video data from encoder 30, and the combined data is recorded by digital recorder 40 (if recorder 40 complies with the DVD-VR standard, recording is made by inserting video packs and buffered audio packs in data units VOBU).

<4> Upon making time-slip/follow-up playback, since audio decoder 23 is not used, decoder 23 can be used to decode audio data in time-slip/follow-up playback.

In the above process, video/audio synchronization errors are generated. As a means for solving such problem, the timing is adjusted upon buffering audio MPEG data. Alternatively, if only playback in this system is premised, data including synchronization errors may be recorded, and audio data may be delayed upon playback (video/audio synchronization is achieved upon playback).

Note that the present invention is not limited to the aforementioned embodiments themselves, and can be embodied by variously modifying required constituent elements without departing from the scope of the invention when it is practiced.

For example, the system of the above embodiment has exemplified a case using only one audio decoder. The method of this system is effective when information which is present in digital broadcasting and is lost when it is converted into an analog signal (e.g., service information of data broadcasting or the like) is to be appended to MPEG digital data output from encoder 30, and only one device which performs this process (service information process or the like) is available. In this case, the method of using audio decoder 23 can be applied to that one device (for example, a decoder device for data broadcast is not used in a recording system, and this device is used to decode corresponding data in data which is played back in the time-slip/follow-up playback mode). Also, the present invention can be practiced when a virtual DVD/HDD recorder is implemented by software on a personal computer.

Also, various inventions can be formed by appropriately combining a plurality of required constituent elements disclosed in the embodiment. For example, some required constituent elements may be deleted from all the required constituent elements disclosed in the embodiment. Furthermore, required constituent elements according to different embodiments may be combined as needed.

1. An AV system comprising:
a first video decoder configured to provide a first video signal by decoding source video data;
an encoder configured to re-encode the first video signal decoded by the first video decoder to rate-converted video data at a rate different from the source video data;
a digital recorder/player configured to record and/or play back source audio data corresponding to the source video data and the re-encoded rate-converted video data;
a second video decoder configured to provide a second video signal by decoding the rate-converted video data played back from the digital recorder/player while the digital recorder/player records the source audio data and the rate-converted video data; and
an audio decoder configured to provide an audio signal by decoding the source audio data played back from the digital recorder/player while the digital recorder/player records the source audio data and the rate-converted video data.

2. A system according to claim 1, further comprising a buffer configured to temporarily store the source audio data, and to output the stored source audio data at a timing synchronous with the re-encoded rate-converted video data.

3. A system according to claim 1, wherein both the first and second video decoders have an MPEG decode function, the encoder has an MPEG encode function, and the audio decoder has a decode function corresponding to an encode format of the source audio data.

4. A digital recorder comprising:
a first MPEG video decoder configured to provide a first video signal by decoding MPEG-encoded source video data;
an MPEG encoder configured to re-encode the first video signal decoded by the first video decoder to rate-converted video data at a rate different from the source video data;
a digital recorder/player configured to record and/or play back source audio data corresponding to the source video data and the re-encoded rate-converted video data using an optical disc and/or magnetic disc;
a second MPEG video decoder configured to provide a second video signal by MPEG-decoding the rate-converted video data played back from the digital recorder/player while the digital recorder/player records the source audio data and the rate-converted video data; and
an audio decoder configured to provide an audio signal by decoding the source audio data played back from the digital recorder/player while the digital recorder/player records the source audio data and the rate-converted video data.

5. A recorder according to claim 4, further comprising a buffer configured to temporarily store the source audio data, and to output the stored source audio data at a timing synchronous with the re-encoded rate-converted video data.

6. A recorder according to claim 4, wherein both the first and second video decoders have an MPEG decode function, the encoder has an MPEG encode function, and the audio decoder has a decode function corresponding to an encode format of the source audio data.

7. A television apparatus comprising:
a tuner unit configured to receive broadcasting, and to output received content as source video data;
a first video decoder configured to provide a first video signal by decoding the source video data;
an encoder configured to re-encode the first video signal decoded by the first video decoder to rate-converted video data at a rate different from the source video data;
a digital recorder/player configured to record and/or play back source audio data corresponding to the source video data and the re-encoded rate-converted video data;
a second video decoder configured to provide a second video signal by decoding the rate-converted video data played back from the digital recorder/player while the digital recorder/player records the source audio data and the rate-converted video data;
an audio decoder configured to provide an audio signal by decoding the source audio data played back from the digital recorder/player while the digital recorder/player records the source audio data and the rate-converted video data; and
a display unit configured to display at least one of source video data from the tuner unit, the first video signal, and the second video signal.

8. An apparatus according to claim 7, further comprising a buffer configured to temporarily store the source audio data, and to output the stored source audio data at a timing synchronous with the re-encoded rate-converted video data.

9. An apparatus according to claim 7, wherein both the first and second video decoders have an MPEG decode function, the encoder has an MPEG encode function, and the audio decoder has a decode function corresponding to an encode format of the source audio data.
